(19) United States
(12) Patent Application Publication
(10) Pub. No.: US 2001/0018810 A1
(43) Pub. Date: Sep. 6, 2001

(54) Spacecraft advertisement method and system

(76) Inventor: Charles M. Chafer, Houston, TX (US)

Correspondence Address: George T. Marcou, Kilpatrick Stockton LLP, Suite 800, 700 - 13th Street, N. W., Washington, DC, 20005, US

(21) Appl. No.: 09/811,539

(22) Filed: Mar. 20, 2001

Related U.S. Application Data
(60) Provisional application No. 60/228,743, filed on Aug. 30, 2000.

(51) Int. Cl. G09F 7/00

(52) U.S. Cl. 40/584

(57) ABSTRACT

A novel method for advertising in space missions is provided. The method includes providing a spacecraft with an advertisement location on an external portion of the spacecraft (e.g., on a surface of a solar sail), creating an advertisement of an entity that sells goods or services to the general public, and placing the advertisement of the entity on the advertisement location. The present invention provides significant advantages over existing methods of advertising in relation to space missions, increasing revenues generated therein and enhancing development of space missions and technology.

This application claims priority to Provisional application No. 60/228,743, filed Aug. 30, 2000. The disclosure of said Provisional Application is incorporated by reference in its entirety as though recited herein in full.

The present invention is related to applicant's co-pending provisional patent application entitled System and Method for Public Participation in Space Missions and to applicant's co-pending provisional patent application entitled Method And System for Generating Revenues in Space Missions, both of which applications are to the present inventive entity and have the same filing date of the present application, the entire disclosures of which are incorporated herein by reference.

### BACKGROUND OF THE INVENTION

1. Field of the Invention

The present invention relates to methods and systems for advertising in relation to space missions and, for example, in advertising in relation to public participation space missions.

2. Description of the Related Art

Historically, advertising in relation to space missions has included television ads, newspaper ads, and various advertising means to terrestrial consumers that are separate from the physical spacecraft used in space missions.

While the display of corporate logos on the sides of “rockets” that are visible prior to and during the launch from the earth's surface has been considered, such displays are limited and do not contain the advantages and benefits of the present invention.

Moreover, while national identifiers (e.g., identifying the United States) have been placed on rockets, on the SPACE SHUTTLE and on the SPACE STATION, such identifiers are not advertisements for commercial products or services and lack the substantial benefits and advantages of the present invention.

Despite existing methods, there remains a great need for new advertising systems and methods in relation to space missions. It is well known that space missions are typically highly expensive. This great expense creates a substantial barrier to rapid advancements in space flight, and, hence, to rapid advancements in technology and in society in general. Despite the high costs of space travel, the assignee of the present invention, Encounter 2001, LLC (see http://www.encounter2001.com), is bringing real space missions more directly to the public by, for example, enabling members of the public to send personal data (e.g., written information, images and the like) and material (e.g., personal DNA samples, such as hair samples) into space as participants in actual space missions. In addition, Celestis, Inc., an affiliate of Encounter 2001, LLC has successfully launched cremation burial space flights—e.g., including space burials of the famous celebrities Timothy Leary and Gene Roddenberry.

The present assignee has discovered that methods and systems of advertising in space missions can be significantly improved upon. By bringing new methods and systems of advertising in space missions, the present assignee strives to bring space missions more directly to the public, to increase revenues and funding for space missions.

### SUMMARY OF THE INVENTION

The present invention overcomes various limitations of existing advertising methods and systems for space missions.

In one embodiment of the invention, visual advertisements are provided on spacecrafts themselves. Preferably, the advertisements are located on solar sails and are viewable upon the unfurling of the solar sails. The advertisements are preferably viewable via remote cameras (e.g., mounted on rocket upper stages used to launch the spacecraft, on reusable orbital platforms such as a space shuttle or a space station, etc.) or via terrestrial means such as earth-based telescopes or the like.

The above and other aspects, features and advantages of the invention will be further appreciated in view of the following description of the preferred embodiments of the invention.

### BRIEF DESCRIPTION OF THE DRAWINGS

The present invention is shown by example, and not limitation, in the accompanying Figures, in which:

FIG. 1 is a schematic diagram of a spacecraft having an advertisement distant from the earth's surface;

FIG. 2(A) is a schematic diagram of a spacecraft having a solar sail; and

FIG. 2(B) is a schematic diagram of a solar sail having an advertisement thereon.

### DETAILED DESCRIPTION OF THE PREFERRED EMBODIMENTS

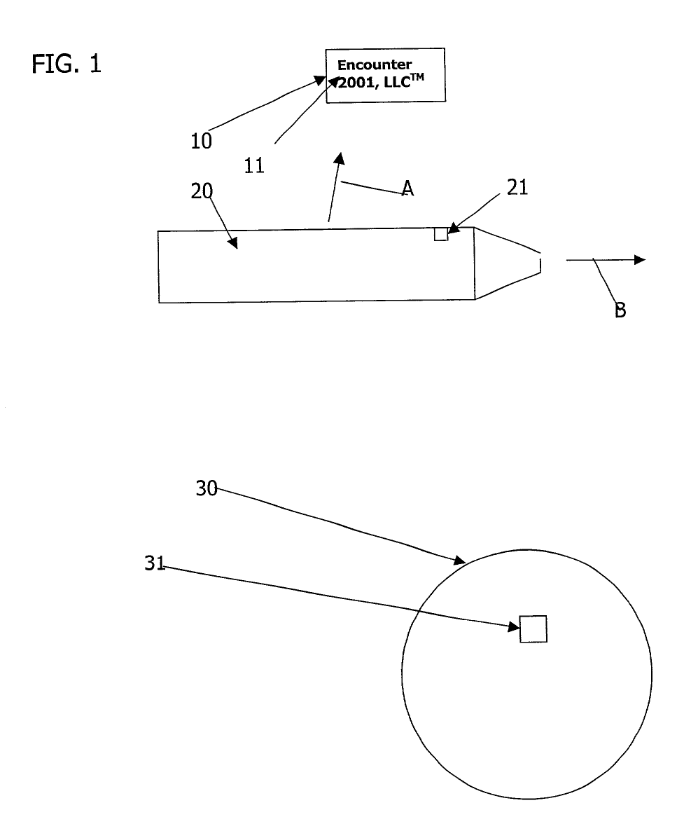

As shown in FIG. 1, according to a first preferred embodiment of the invention, a spacecraft 10 is provided with a region on an external surface thereof for one or more advertisement. In the illustrated embodiment, the advertisement reads “Encounter 2001, LLC™.”

Preferably, the advertisement is physically located or visible on an exterior surface of a spacecraft (i.e., on a surface that is exterior at least during the operation of the spacecraft). In contrast to rockets that are readily viewable from the ground surface before or during launching, spacecraft are not readily viewable during operation. Typically, this exterior surface of the spacecraft is obstructed from viewing before or during launching. In contrast to rockets, spacecraft are usually substantially smaller than rockets and are designed for space travel and not for withstanding atmospheric and other conditions during launching from the earth's surface. Preferably, the spacecraft is of a type including propulsion systems and control systems for directing the path of travel of the spacecraft.

In the embodiment shown in FIG. 1, the spacecraft 10 follows a path A away from and out of the earth's atmosphere. As also shown in FIG. 1, the spacecraft 10 is preferably initially mounted upon a carriercraft 20 that is designed to carry the spacecraft to a predetermined altitude (e.g., from within the earth's atmosphere into outer space) and to then deploy the spacecraft 10. In the embodiment of FIG. 1, the carriercraft 20 may follow, e.g., a path B generally transverse to the path A of the spacecraft. The carriercraft 20 can include, for example, a rocket, a reusable orbital platform or another carrier craft.

Preferably, the spacecraft is launched as a secondary payload. In one exemplary embodiment, it is included on an ARIANE 5 rocket. In one example, the ARIANE 5 rocket can be used to place a small spacecraft in geo-synchronous transfer orbit. At a certain point in time (e.g., coordinated with television broadcasting, web casting, etc.), the spacecraft can be propelled along a particular path—e.g., out of the earth's atmosphere.

Alternatively, the spacecraft 10 can follow any known trajectory or path. In just one of many illustrative embodiments, the spacecraft may be sent on a trajectory away from our planet's solar system. In one illustrative example, the spacecraft 10 may initially be launched into an earth geo-synchronous transfer orbit (GTO) as an intermediate orbit. Then, the spacecraft 10 may be propelled by an internal rocket motor to another planet, e.g., Jupiter, to use the planet's gravity to boost itself on a trajectory outside of the solar system. The spacecraft 10 can also be directed into other known trajectories, such as into orbit around the earth, around the sun or along another path.

As shown in FIG. 1, the spacecraft is uniquely adapted so as to include an advertisement 11 on the external surface thereof. In the preferred embodiment, this advertisement is mounted in such a manner to enable viewing of the advertisement upon deployment of the spacecraft 10 from the carrier 20. That is, the advertisement 11 is, in some preferred embodiments, viewable upon deployment of the spacecraft 10—and, in preferred embodiments, not upon the initial launch of the carrier 20 (e.g., typically from the earth's surface).

Accordingly, a spectacular advertisement can be created that is viewed in space. The image of the advertisement in space is most preferably transmitted to numerous consumers of goods or services sold by the advertising entity, and most preferably, in substantially real time.

In one preferred embodiment, the advertisement 11 is viewed via a video camera 21 supported by the carriercraft 20. In this latter embodiment, the system preferably sends signals to the earth for viewing. In this case, the advertisement position on the spacecraft, the video camera 21 location and the deployment of the spacecraft 10 should be coordinated so that the video camera 21 will have a substantially direct view of the advertisement 11 for a period of time to allow viewing during deployment. Preferably, in some embodiments, the video transmission is broadcasted in substantially real time for television viewing. Preferably, in some embodiments, the video transmission is additionally or alternatively transmitted over a computer network for access by consumers of the advertised products or services via their personal computers or the like, such as over the Internet or the World Wide Web. This Internet or webcast transmission is most preferably performed in substantially real time. In the latter case, the video transmission may be limited to smaller video clips or pictures where transmission bandwith is limited. When an advertisement is displayed on the Internet, a web page or the like displaying the advertisement may also be provided with a link to an address, e.g., via a uniform resource locator (URL), of a web page of the advertising entity to direct the consumers to render purchases or to receive additional information. In some embodiments, the web cast can include a streaming media presentation that is transmitted to a local computer of a member of the public only after receipt of payment therefore, the payment being made on-line via credit card, virtual wallet or other electronic payment means. The playback of the streaming media can be carried out by a suitable streaming media player, which could be executing on the user's local computer as a plug-in module for a browser application. Some examples of suitable streaming media players include the MICROSOFT MEDIAPLAYER, the APPLE COMPUTER QUICKTIME and the REALVIDEO or REALPLAYER programs provided by REAL NETWORKS. In addition, the present invention could use other available streaming players.

In another preferred embodiment, as shown in FIG. 1, the advertisement can be viewable from earth 30, e.g., via an earth-based telescope 31. In some preferred embodiments, the telescope 31 can be a large commercial telescope and images obtained therewith can be recorded and transmitted-as in the preceding embodiment-to consumers via television broadcasting, Internet broadcasting and/or other forms of image broadcasting. Moreover, the images can also be reproduced within newspapers, magazines, and other materials. Moreover, the images can also be reproduced onto assorted secondary items such as T-shirts, coffee mugs, plates, posters and other displayable novelty items.

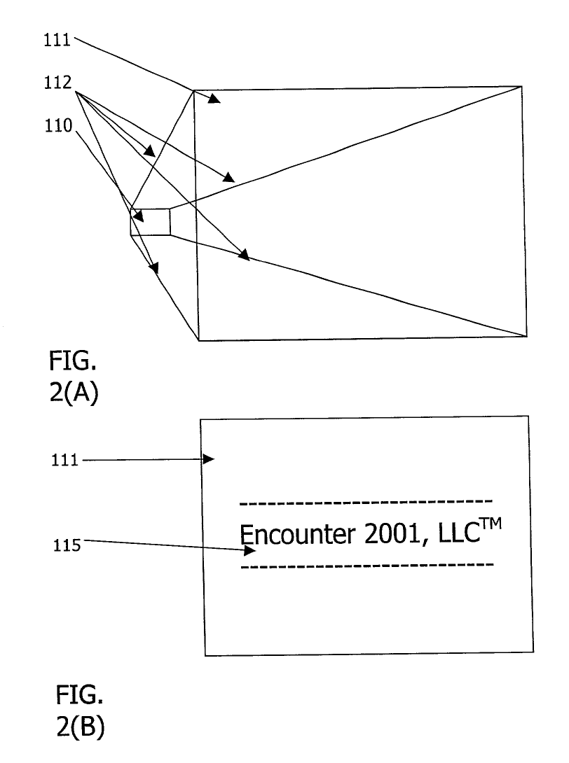

FIGS. 2(A) and 2(B) illustrate one preferred embodiment of the invention wherein a spacecraft 100 is used that includes a solar sail 111. In this latter embodiment, the advertisement 115 is most preferably located on the solar sail 111. As is known in the art, solar sails can be used to power spacecraft via reflection of solar and the like radiation. See, e.g., U.S. Pat. No.: 5,850,992 (Method for Controlling the Pitch Attitude of a Satellite By Means of Solar Radiation); U.S. Pat. No. 5,183,225 (Spacecraft That Utilizes Sight Pressure and Method of Use); U.S. Pat. No. 4,909,460 (Device and Method for Aiming a Space Probe Toward a Celestial Body); U.S. Pat. No. 4,759,517 (Station-Keeping Using Solar Sailing); U.S. Pat. No. 4,614,319 (Solar Sail), the entire disclosures of which are incorporated herein by reference. Solar sails may be made with expansive surface areas—e.g., multiple kilometers in width—upon which very large advertisements can be displayed. In some embodiments, the solar sails could potentially be viewable by consumers or laymen with moderate telescopes, binoculars or the like; in these latter embodiments, the advertisements would have very substantial visual impact upon the viewing consumers of the products or services sold by the advertising entity.

In preferred embodiments, the advertisement can include: a company name (e.g., Encounter 2001, LLC as shown); a company logo (e.g., such as a NIKE SWOOSH or the like); a company slogan (e.g., such as NIKE'S “JUST DO IT”); an offer made by the company to its consumers (e.g., “buy one get one free”); sale information provided by the company to its consumers (e.g., “end of the millennium sale”); a company web page address, URL or other computer accessible graphical user interface address (e.g., http://www.encounter2001.com); and/or any other company identifiers or information to be provided to its consumers.

In the most preferred embodiments of the invention, the spacecraft 10, 100 is a space craft utilized on a public participation space mission. Preferably, the spacecraft 10, 100 contains data, images, statements, material, objects or other information or the like of individual consumers that is carried within the spacecraft. In this manner, the individual consumers will have a heightened personal interest in the space mission, greatly enhancing advertisement value for the advertising companies. Preferably, the public participation component of the space mission is only one component of the entire space mission. For example, the carriercraft 20 preferably contains government, scientific and/or other cargo, experiments and the like. Accordingly, the present invention provides a significant means for defraying costs in space missions, benefiting all entities utilizing the carriercraft.

In another preferred embodiment, the spacecraft 10, 100 is a craft used in a spacecraft race. Preferably, the spacecraft race is between multiple solar sail powered spacecraft. The spacecraft race can be, for example: a) a race around another planet, e.g., mars or another planet; b) a race around the moon; c) a race around the earth; or c) a race along another desired race flight path. The spacecraft race may alternatively be a race to be the first spacecraft to achieve a particular task—e.g., such as the first solar sail spacecraft to successfully travel a particular distance, or to orbit the moon, or to orbit mars or the like. This latter form of “race” would attract significant media attention in a manner parallel to the media attention received by various individuals seeking to sail in a balloon around the circumference of the earth.

While the present invention has been described above with respect to preferred embodiments of the invention, the present invention is not limited thereto, but encompasses all other modifications, variations and embodiments that would be apparent to those in the art based on this disclosure.

What is claimed is:

1. A method of advertising commercial products or services, comprising:
a) providing a spacecraft with an advertisement location on an external portion of the spacecraft;
b) creating an advertisement of an entity that sells goods or services to the general public; and
c) placing said advertisement of said entity on said advertisement location.

2. The method of claim 1, wherein said spacecraft is delivered into space via a carriercraft, and said advertisement is not viewable before or during launching of the carriercraft from the earth's surface.

3. The method of claim 1, further including providing a camera on a carriercraft carrier from which the spacecraft is deployed and obtaining images of the spacecraft after deployment which show the advertisement located on the advertisement location, and transmitting the images for reproduction or broadcast to the public.

4. The method of claim 1, further including providing a telescope or the like on the earth from which images of the advertisement located on the advertisement location can be seen, and transmitting the images for reproduction or broadcast to the public.

5. The method of claim 1, wherein said spacecraft includes a solar sail and said advertisement is along a surface of the solar sail.

6. The method of claim 1, wherein said spacecraft includes at least one large sheet or membrane along which the advertisement is mounted.

7. The method of claim 6, wherein the large sheet or membrane is a solar sail.

8. The method of claim 6, wherein the advertisement is larger than 1/2 kilometer in length.

9. The method of claim 7, wherein the advertisement is larger than 1/2 kilometer in length.

10. The method of claim 7, wherein the advertisement is larger than 1 kilometer in length.

11. The method of claim 8, wherein the advertisement is larger than 1 kilometer in length.
